(19) United States
(12) Patent Application Publication
(10) Pub. No.: US 2016/0266465 A1
(43) Pub. Date: Sep. 15, 2016

(54) Scanning Pattern Projection Methods and Devices

(71) Applicant: Jahangir S Rastegar, Stony Brook, NY (US)

(72) Inventor: Jahangir S Rastegar, Stony Brook, NY (US)

(73) Assignee: Omnitek Partners LLC, Ronkonkoma, NY (US)

(21) Appl. No.: 15/069,451

(22) Filed: Mar. 14, 2016

Related U.S. Application Data
(60) Provisional application No. 62/132,434, filed on Mar. 12, 2015.

(51) Int. Cl. G02F 1/29

(52) U.S. Cl. CPC G02F 1/292

(57) ABSTRACT

An apparatus including: a first conductive layer extending between opposed ends and at a reference potential; a second conductive layer extending widthwise between first and second ends and apart from the first conductive layer and including a resistive layer, substantially uniform between the first and second ends, such that a voltage potential applied across the second conductive layer ranges uniformly across the width of the second conductive layer from a first voltage potential at the first end to a second voltage potential at the second end; a liquid crystal layer between the first and second conductive layers to variably shift a phase of light incident thereto linearly based upon a voltage potential across the first and second conductive layers; and a diffraction grating extending between first and second ends and adjacent to one of the first and second conductive layers, the diffraction grating receiving and diffracting the phase shifted light.

### CROSS-REFERENCE TO RELATED APPLICATION

This application claims priority to U.S. Provisional Application No. 62/132,434 filed on Mar. 12, 2015, the contents of which is incorporated herein by reference.

### BACKGROUND

1. Field

The present invention relates generally to methods and devices for projecting scanning patterns over objects, and more particularly to methods and devices to generate diffraction based structured light scanner using liquid crystal phase modulation.

2. Prior Art

Projection of diffraction based structured light onto a target is a widely employed method in 3D imaging devices. One main advantage of such scanning systems is that they do not require optical reflection lens systems and that they can provide sharp patterns regardless of the projecting distance. However, to spatially move the projected pattern over the object, such as in a scanning type of motion, actuated mirror motion systems of different types have generally been employed to change the direction of light direction. Such mirror systems require moving parts and generally suffer from relatively slow response time, large size, and high actuation energy requirement.

For example, U.S. Pat. No. 8,662,707, titled “Laser Beam Pattern Projector” discloses a device which projects structured light that is generated using a diffractive element, while scanning of the projected pattern is achieved using mechanically driven mirrors.

In general, for high precision 3D imaging, it is highly desirable to project various scanning patterns onto the object. It is also highly desirable that the scanning is not mechanical, so that it can be done at high speeds and issues such as wear and component breakage and the like are eliminated. The devices can also be made to withstand accidental drops and vibration significantly better.

### SUMMARY

A need therefore exists for methods and devices for projecting scanning patterns over objects in which mechanical means are not used to generate the scanning motion of the projected patterns.

An objective is to provide new methods and related devices for projecting scanning patterns over objects. The developed methods and devices are optical and use a diffraction technique and use novel techniques to achieve pattern scanning using liquid crystal layers with specifically designed electrode layers.

Accordingly, a scanning apparatus is provided. The scanning apparatus comprising: a first conductive layer extending between opposed ends and being at a reference potential; a second conductive layer extending widthwise between opposed first and second ends and situated apart from the first conductive layer, the second conductive layer comprising a resistive layer having a resistivity which is substantially uniform between the first and second ends of the second conductive layer such that a voltage potential applied (V) across the second conductive layer will range uniformly across the width of the second conductive layer from a first voltage potential (V1) at the first end to a second voltage potential (V2) at the second end; a liquid crystal layer situated between the first and second conductive layers and configured to variably shift a phase of light incident thereto linearly based upon a voltage potential across the first and second conductive layers; and a diffraction grating extending between first and second ends and situated adjacent to one of the first and second conductive layers, the diffraction grating configured to receive the phase shifted light from the liquid crystal layer and diffract the phase shifted light.

The apparatus can further comprise a voltage source which generates the voltage potential (V) as a time varying voltage so as to generate a continuously varying phase shift across the liquid crystal layer.

The apparatus phase shifted diffracted light can project a pattern on an object. The voltage potential (V) cam be varied as a function of time so as to scan the surface of the object with the pattern.

The diffraction grating can comprise a reflective diffraction grating. The diffraction grating can reflect the phase shifted light back through the liquid crystal layer.

The diffraction grating can comprise a reflective diffraction grating that is coupled to receive the phase shifted light and reflect the phase shifted light back through the liquid crystal layer for a second phase shifting.

The apparatus first and second conductive layers can be transparent to pass light incident thereto.

The first and second conductive layers can have at least one of an inductivity and a capacitance.

Also provided is a scanning pattern projection apparatus, comprising: a first conductive layer extending between opposed ends defining a width and opposed edges defining a length, the first conductive layer being at a reference potential; a second conductive layer extending between opposed ends defining a width and opposed edges defining a length, the second conductive layer comprising a resistive layer having first through fourth electrodes each separate from each other and configured to receive first through fourth respective voltage potentials (V1, V2, V3, V4, respectively), the second conductive layer having a resistivity which is substantially uniform across the length and width thereof such that voltage potentials range uniformly across the width and across the length of the second conductive layer; a liquid crystal layer situated between the first and second conductive layers and configured to variably shift a phase of light incident thereto linearly based upon distributed voltage potentials across the first and second conductive layers; and a diffraction grating extending between first and second ends and situated adjacent to one of the first and second conductive layers, the diffraction grating configured to receive the phase shifted light from the liquid crystal layer and diffract the phase shifted light.

The first through fourth voltage potentials (V1, V2, V3, V4, respectively) can be varied over time in accordance with a voltage profile. The first through fourth voltage potentials (V1, V2, V3, V4, respectively) can be varied over time to scan an object using the projected pattern. The projected pattern can be shifted based upon relative magnitudes of the first through fourth voltage potentials (V1, V2, V3, V4, respectively). The first through fourth voltage potentials (V1, V2, V3, V4, respectively) can be varied over time to spatially shift the projected pattern over time. The first through fourth voltage potentials (V1, V2, V3, V4, respectively) can be varied over time to generate a two-dimensional scanning pattern projected onto an object.

The first through fourth voltage potentials (V1, V2, V3, V4, respectively) can be varied such that V2−V1=V4−V3.

The diffraction grating can have a diffraction grating pattern configured so that the diffracted phase shifted light is projected to form a circular or grid pattern on an object.

The first through fourth electrodes can be located at first through fourth corners, respectively, of the second conductive layer.

The phase shifted diffracted light can project a pattern on an object. The at least one of the first through fourth voltage potentials (V1, V2, V3, V4, respectively) can be varied as a function of time so as to scan a surface of an object with the diffracted phase shifted light projected as a pattern.

Still further provided is an apparatus, comprising: a plurality of scanning projection devices, each scanning projection device situated adjacent to another of the plurality of scanning projection devices and comprising: a first conductive layer extending between opposed ends and being at a reference potential; a second conductive layer extending widthwise between opposed first and second ends and situated apart from the first conductive layer, the second conductive comprising a resistive layer having a resistivity which is substantially uniform between the first and second ends of the second conductive layer such that a voltage potential (V) applied across the second conductive layer will range uniformly across the width of the second conductive layer from a first voltage potential (V1) at the first end to a second voltage potential (V2) at the second end; a liquid crystal layer situated between the first and second conductive layers and configured to variably shift a phase of light incident thereto linearly based upon a voltage potential across the first and second conductive layers; and a diffraction grating extending between first and second ends and situated adjacent to one of the first and second conductive layers, the diffraction grating configured to receive the phase shifted light from the liquid crystal layer and diffract the phase shifted light.

The plurality of scanning projection devices can be arranged in a linearly pattern. The voltage potential (V) applied across each scanning projection devices can phase shift the phase shifted light by a phase offset (Δφ₁).

The voltage potential (V) applied across the second conductive layer of at least two of the scanning projection devices can be equal so as to obtain the same slope of a wave front.

The voltage potential (V) applied across the second conductive layer of at least two of the scanning projection devices can be varied to obtain a desired phase shift profile.

The phase shifted diffracted light can project a pattern on an object. The at least one voltage potential (V) of at least one of the plurality of scanning projection devices can be varied as a function of time so as to scan a surface of an object with a pattern formed by a projection of the diffracted phase shifted light.

The first and second conductive layers can have at least one of an inductivity and a capacitance.

### BRIEF DESCRIPTION OF THE DRAWINGS

These and other features, aspects, and advantages of the apparatus of the present invention will become better understood with regard to the following description, appended claims, and accompanying drawings where:

FIG. 1A illustrates the schematic of the first embodiment of a scanning pattern projection device.

FIG. 1B illustrates the voltage profile along the width of the resistive conductive layer of the first embodiment of FIG. 1A of the scanning pattern projection device.

FIG. 1C illustrates projected scanning pattern obtained with the first embodiment of FIG. 1A of the scanning pattern projection device.

FIGS. 2A and 2B show first and second examples of possible diffraction gratings that can be used in the diffractive layer of the embodiment of FIG. 1A.

FIG. 3 illustrates the process of diffraction of a coherent light source by a diffraction grating element and the line (strip) patterns formed over an object.

FIG. 4 illustrated the schematic of another embodiment of the scanning pattern projection device that uses a diffractive element in reflection configuration.

FIG. 5 illustrates an isometric view of the schematic of the first embodiment of the scanning pattern projection device of the present invention shown in FIG. 1A.

FIG. 6 illustrates the voltage profile along the width and length of the electrically resistive conductive layer of the embodiment of FIG. 5 of the scanning pattern projection device.

FIG. 7 illustrates an example of scanning projected patterns, in this case concentric circular strips, using appropriately provided diffraction grating patterns with the embodiment of FIG. 5.

FIG. 8 illustrates another example of scanning projected pattern, in this case a grid pattern, using appropriately provided diffraction grating patterns with the embodiment of FIG. 5.

FIG. 9 illustrates the cross-sectional view of two scanning pattern projection device sections for achieving larger angle between the incident wave front and the phase shifted wave front.

FIG. 10 illustrates the cross-sectional view of a single device section of the scanning pattern projection device of FIG. 9, constructed as the diffractive element in reflection configuration as illustrated in FIG. 4.

FIG. 11 illustrates the method of achieving a continuous phase shifting across multiple sections of scanning pattern projection device by providing an appropriate amount of phase offset between each two section of the device.

FIG. 12 illustrates an alternative method of achieving a continuous phase shifting across multiple sections of scanning pattern projection device by providing two top and bottom electrically resistive electrode layers for each section of the scanning pattern projection device an applying an appropriate varying voltages to both electrode layers.

FIG. 13 shows an example of the possible phase shifting profile along the width of a section of a scanning pattern projection device obtained by varying the electrical resistivity of the conductive layer over different sections of the device.

FIG. 14 shows an example of the possible phase shifting profile along the width of a section of a scanning pattern projection device obtained by varying the thickness of the liquid crystal layer along the width of a section of the device.

### DETAILED DESCRIPTION OF THE PREFERRED EMBODIMENT

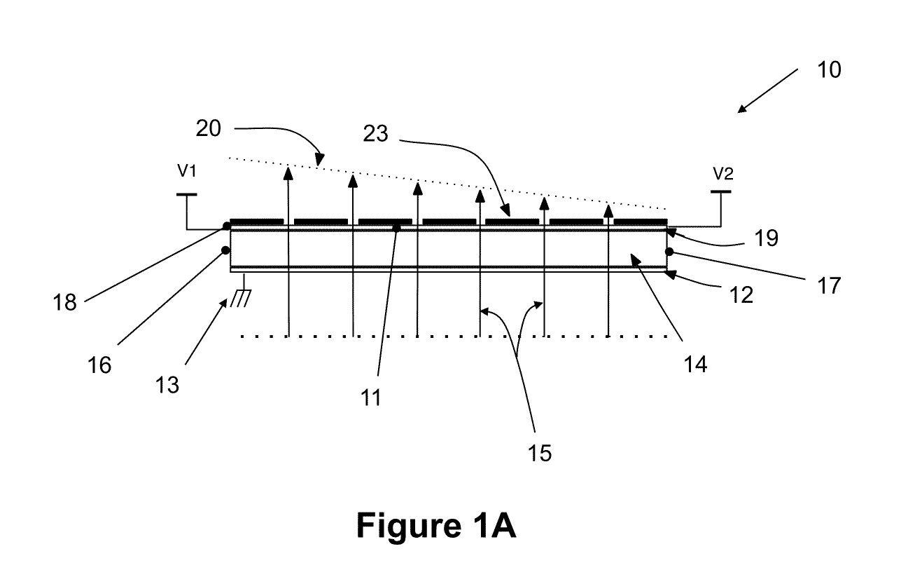

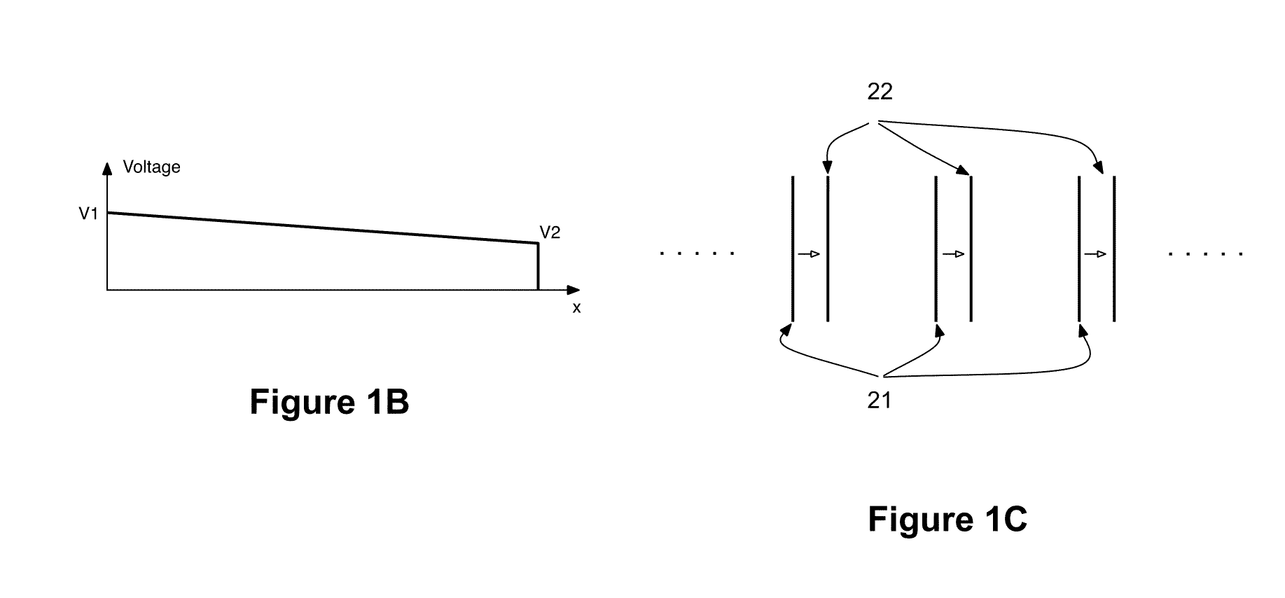

A schematic of the first embodiment 10 of the scanning pattern projection device is shown in the schematic of FIG. 1A. In FIG. 1A a cross-sectional view of the embodiment 10 is shown. The embodiment 10 is considered to be planar and extend a certain length perpendicular to the cross-sectional view of FIG. 1A.

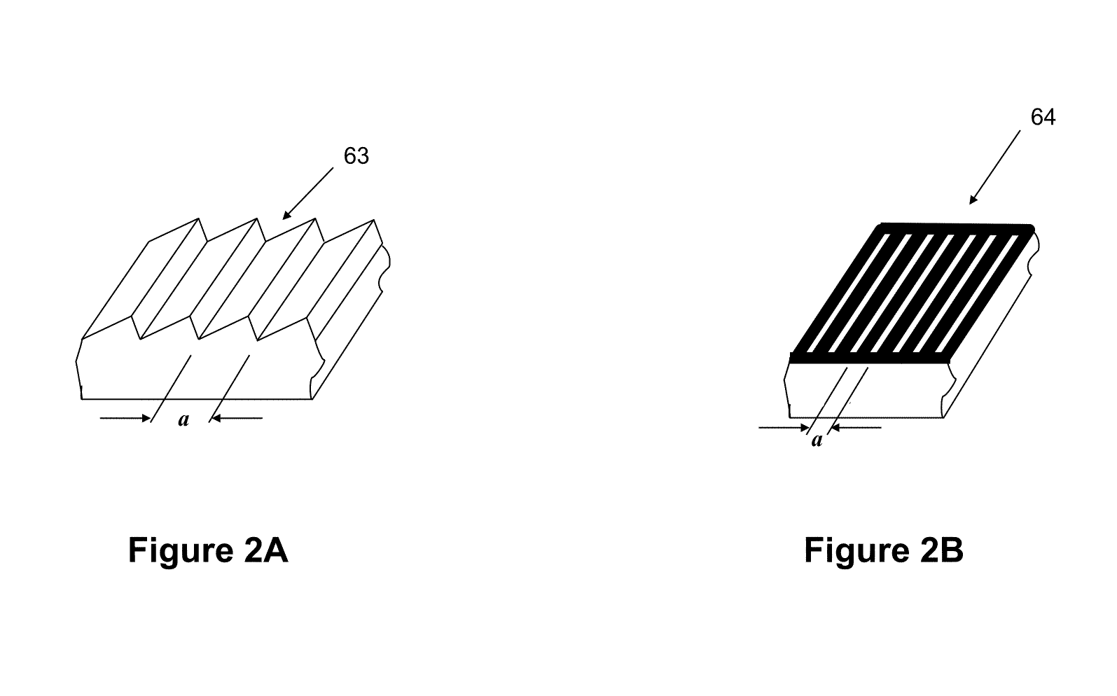

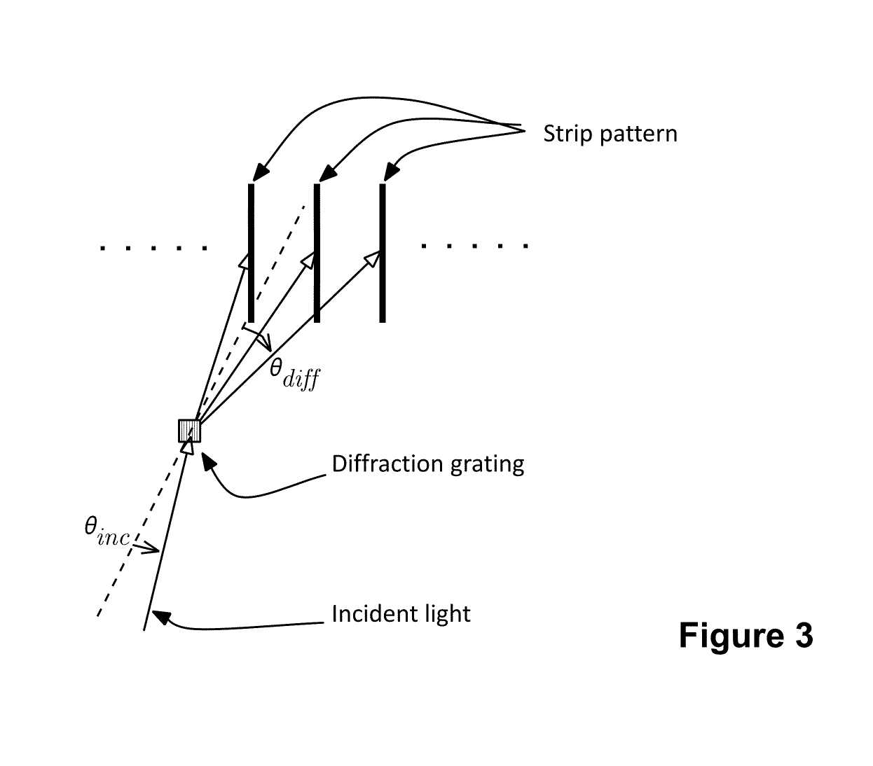

As can be seen in FIG. 1A, the embodiment 10 consists of a liquid crystal layer 14, which is sandwiched between a highly conductive electrode layer 12 and the electrode layer 11, which is considered to have a relatively high electrical resistivity. Both electrode layers 11 and 12 are considered to be transparent to the passing incident light 15. Hereinafter, the incident light is considered to be coherent, monochromic and parallel. The highly conductive electrode layer 12 is grounded, such as at ground 13, as shown in FIG. 1A. A diffractive element layer 23, which can have diffraction grating 63, which can be made of identical, parallel, and equidistant grooves, such as those in FIG. 2A, or multi-slit diffraction grating 64 such as those shown in FIG. 2B, or any other grating types known in the art, which are considered to have infinite length, positioned over the surface of the electrode layer 11. For the gratings, the only parameter to be defined is the periodicity α, which is the separation of two neighboring grooves, FIG. 2A (or multi-slit diffraction grating, FIG. 2B). The optics of diffraction process with diffraction gratings is well known in the art. In FIG. 3, the relationship between angles θ_{diff} of the diffracted strips (line patterns projected on an object positioned in front of the diffraction grating element such as 23 in FIG. 1A) and the incident wave (light) front angle θ_{inc} are defined as

$$sin {θ}_{diff} + sin {θ}_{inc} = p \frac{λ}{a}$$

where λ is the wavelength of the incident light and p is an integer.

The ends 18 and 19 of the electrode layer 11 are connected to an electronic circuit to be described below such that a current can be induced to flow from one of the ends 18 of the electrode layer 11 to the other end 19. As a result, for example when the voltage at the end 18 is V1 and the current is flowing from end 18 to end 19, then due to the electrically resistivity of the electrode layer 11, the voltage will be reduced proportionally to a lower level V2 at the end 19. It will be appreciated by those skilled in the art that if the electrode layer 11 has a uniform electrical resistivity along the width of the layer from end 18 to end 19, then the voltage will linearly drop from the level of V1 to the level of V2 along the width of the electrode layer 11 from one end 18 to the other end 19 as shown in the plot of FIG. 1B. In which case, the electric field in the liquid crystal layer 14 between the electrode layer 11 and the highly conductive and grounded (or any reference voltage) layer 12 will be linearly varied from its end 16 to its other end 17. As a result, the liquid crystal layer 14 will shift the phase of the incident light 15 decreasingly and in a linear manner from the one end 16 to the other end 17 as shown schematically by the dotted line 20. The magnitude of the phase shift at the one end 16 of the liquid crystal layer 14 is dependent on the level of the voltage V1, while the slope of the phase shift drop line 20 and the magnitude of phase shift at the other end 17 (corresponding to the voltage V2) of the liquid crystal layer 14 is dependent on the electrical resistance of the electrode layer 11.

As a result, the phase of the incident light 15 is changed continuously along the diffraction grating element 23 from the one end 16 to the other end 17 of the device embodiment 10 of FIG. 1A. Now if the voltage V1=V2=0, i.e., if the phase shift of the incident light 15 along the width of the device 10 from the one end 16 to the other end 17 is the same (in this case zero). The diffraction grating element 23 will then cause line patterns 21 to be projected onto the surface of the object positioned certain distance in front of the device 10 as shown in FIG. 1C. Now if the voltages V1 and V2 are applied to the ends 18 and 19, respectively, of the electrically resistive electrode layer 11, thereby causing a uniformly decreasing voltage along the width of the electrode layer 11 from the voltage V1 at the end 18 to the voltage V2 at the other end 19 of the said electrode layer 11, as shown in FIG. 1B, then the phase of the incident light 15 is changed most at the end 16 of the device 10, dropping linearly to its lowest shifting magnitude at the end 17 of the device 10. As a result, the projected line patterns 21, FIG. 1C, will be shifted a certain distance either to the right or to the left, such as shown as being shifted to the right in FIG. 1C. It will be appreciated by those skilled in the art that the amount of shifting of the line patterns 21 to the right or left is dependent on the magnitude of the applied voltage V1 and its drop to the voltage V2, which is made possible due to the electrical resistance of the electrode layer 11 along the width of the device 10 from its end 18 to its other end 19, and the characteristics of the liquid crystal layer and the diffraction grating.

It will be appreciated by those skilled in the art that the projected line patterns 21 will shift to the right if the applied voltage V1 (to the end 18 of the electrode layer 11) is higher than the voltage V2 applied to the end 19 of the electrode layer 11 as shown in FIG. 1C. This is the case since the phase shifting is proportional to the applied voltage across the liquid crystal layer 14, FIG. 1A, which would cause the wave front angle θ_{inc}, FIG. 3, to change accordingly.

Hereinafter and for the sake of simplicity, the object over which the line patterns 21, FIG. 1C, are projected is considered to be flat and parallel with the surface of the device 10, FIG. 1A, i.e., parallel with the frontal surface of the diffraction grating layer 23 as shown in the schematics of FIGS. 2A and 2B.

As was described above, by applying the voltages V1 and V2 to the one end 18 and the other end 19, respectively, of the electrically resistive electrode layer 11, the projected line patterns 21, FIG. 1C, are shifted to the right or left depending on the sign of the applied voltage V1, such as shown to be shifted to the right by the dashed lines 22 in FIG. 1C when the voltage V1 is greater than the voltage V2.

Similarly, by applying time varying voltage patterns V1 and V2 to the one end 18 and to the other end 19, respectively, of the electrically resistive electrode layer 11, the projected line patterns 21, FIG. 1C, would shift to the right or left following the pattern of the applied voltages V1 and V2. For example, by holding the voltage V2 constant and applying a voltage level V1 that varies as a sinusoidal function of time, then the projected line patterns 21 will similarly scan the object surface to the right and left (without any rotation) within a range determined by the amplitude of the sinusoidal voltage V1. It will be appreciated by those skilled in the art that the voltage V1 may be varied over time using any arbitrary profile, and that the projected line patterns 21 would then similarly scan (i.e., shift to the right and left) over the object. It is also appreciated that one may choose to vary both voltages V1 and V2 as a function of time to obtain a desired scanning (shifting) of the light patterns 21 over the object.

Using the schematic of FIGS. 1A, 1B, 1C and 3, one method for the design and operation of a device for projecting scanning line patterns over the surface of an object was described. In this method at least one coherent, monochromic and parallel incident light source is used. Then by generating a continuously varying electric filed across a liquid crystal layer through which the incident light is passed, a continuous phase shift is generated in the incident light before passing through a provided diffraction grating. Scanning of the projected line patterns over the object is then achieved by varying the electric field across the liquid crystal layer as a function of time as was previously described, thereby causing the projected line patterns to similarly shift (scan) over the projected object.

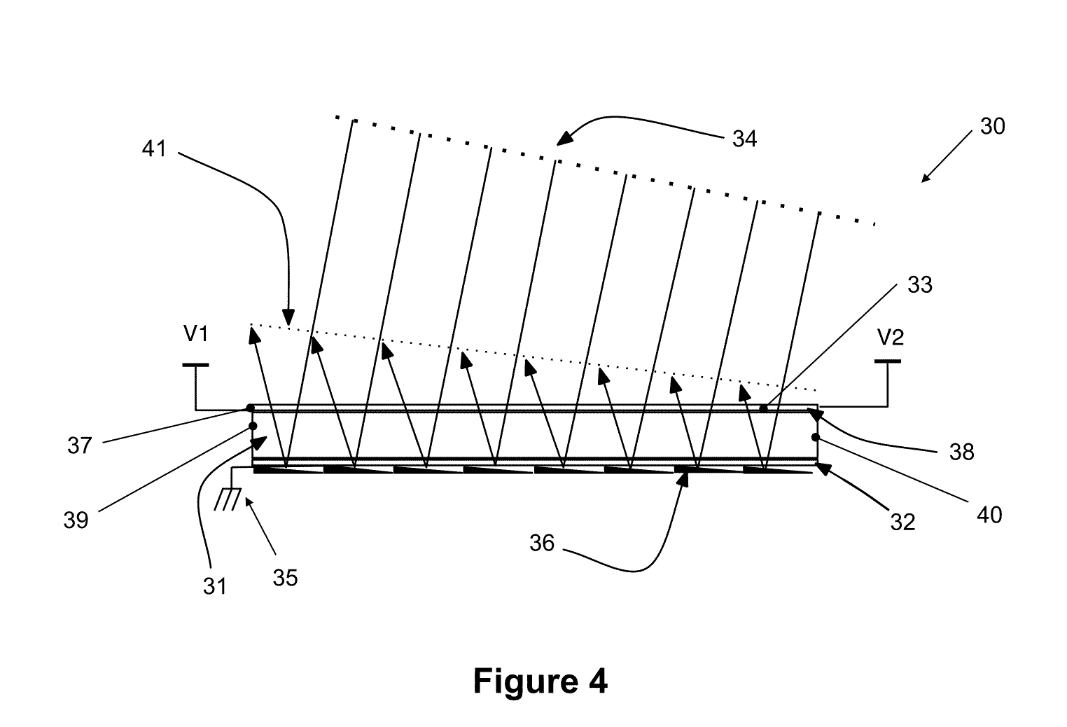

The same method of generating a continuously varying electric field across a liquid crystal layer and thereby generating a continuously varying phase shift in the incident coherent, monochromic and parallel light along the width of the liquid crystal layer described above may be similarly used to generate a continuously varying phase shift on a diffractive grating element in reflection configuration. In such a device and as it is described below, a liquid crystal layer is similarly sandwiched between the phase control electrodes (similar to the electrode layers 11 and 12 in the embodiment 10 of FIG. 1A). The incoming coherent, monochromic and parallel incident light is then passed through the sandwiched layers, thereby achieving a first phase shift depending on the electric field generated between the electrode layers by the applied voltage as was previously described. The phase shifted incident light is then reflected by a reflective diffractive grating element that is positioned behind the sandwiched layers. The reflected incident light undergoes a second phase shift as it passes a second time thought the phase shifting liquid crystal layer and exits the device. By similarly applying a time varying voltage to one end of the electrically resistive electrode layer of the device, a continuously and linearly changing electric field is applied to the liquid crystal layer. The output light phases are thereby similarly modulated. Scanning line patterns are then similarly projected over the surface of an object as was previously described. The schematic of one such embodiment 30 of the scanning pattern projection device is shown in the schematic of FIG. 4.

In FIG. 4, a cross-sectional view of the embodiment 30 is shown. The embodiment 30 is also considered to be planar and extend a certain length perpendicular to the cross-sectional view of FIG. 4.

As can be seen in the schematic of FIG. 4, similar to the embodiment 10 of FIG. 1A, the embodiment 30 also consists of a liquid crystal layer 31, which is similarly sandwiched between a highly conductive electrode layer 32 and the electrically resistive electrode layer 33. Similar to the electrode layer 11 of the embodiment of FIG. 1A, the electrode layer 33 is considered to have a relatively high electrical resistivity, which for the sake of simplicity is considered to be uniform along the width of the device 30. Both electrode layers 32 and 33 are considered to be transparent to the passing coherent, monochromic and parallel incident light 34. The highly conductive electrode layer 32 is grounded at a certain point, such as at point 35, as shown in FIG. 4. A reflective diffraction grating layer 36 is positioned behind the electrode layer 32. The reflective diffraction grating layer 36 can be of a blazed grating type, however, other types of reflective gratings may also be employed.

The one end 37 and other end 38 of the electrically resistive electrode layer 33 are connected to an electronic circuit to be described below such that a current can be induced to flow from the one of the ends 37, 38 of the electrode layer 33 to the other end 37, 38. As a result, for example, when the voltage at the end 37 is V1 and the current is flowing from the end 37 to the end 38, then due to the electrically resistivity of the electrode layer 33, the voltage will be reduced proportionally to a lower level V2 at the end 38. It will be appreciated by those skilled in the art that if the electrode layer 33 has a uniform electrical resistivity along the width of the layer from the end 37 to the end 38, then the voltage will linearly drop from the level of V1 to the level of V2, FIG. 4, along the width of the electrode layer 33 from its end 37 to the end 38 similar to the plot shown in FIG. 1B. In which case, the electric field in the liquid crystal layer 31 between the electrode layer 33 and the highly conductive and grounded (or any reference voltage) layer 32 will be linearly varied from its one end 39 to its other end 40. As a result, the liquid crystal layer 31 will shift the phase of the incoming incident light 34 as well as the reflected incident light 41 decreasingly and in a linear manner from the one end 39 to the other end 40 of the device 30. The magnitude of the phase shift along the length of the liquid crystal layer 31 during the passing of the incident light is dependent on the level of the voltages V1 and V2 as was previously described for the embodiment 10 of FIG. 1A. It will, however, be appreciated that since the incident light is passed twice through the liquid crystal layer 31, the device of the embodiment 30 of FIG. 4 achieves twice as much phase shift and thereby twice as much shift in the projected line patterns as the device of the embodiment 10 of FIG. 1C.

If the voltage V1=V2=0, i.e., if the phase shift of the incoming incident light 34 as well as the phase shift of the reflected incident light 41 are the same (in this case zero) along the width of the device 30 from the one end 39 to the other end 40, then the first set of line patterns similar to lines 21 shown in FIG. 1C will be projected onto the object positioned a certain distance in front of the device 30.

Then if voltage V1 and a lower voltage V2 are applied to the one end 37 and to the other end 38, respectively, of the electrically resistive electrode layer 33, thereby causing a uniformly decreasing voltage along the width of the electrode layer 33 from the voltage V1 at the end 37 to the voltage V2 at the other end 38 of the electrically resistive electrode layer 33 as shown in the plot of FIG. 1B, then the phase of the incoming incident light 34 as well as the phase of the reflected incident light 41 are shifted most at the end 39 of the device 30, dropping linearly to its lowest shifting magnitude at the end 40 of the device. As a result, the projected line patterns will be similarly shifted a certain distance either to the right or to the left, such as shown in FIG. 1C, where the line patterns 21 are shifted to the right, as shown in FIG. 1C. It will be appreciated by those skilled in the art that the amount of the shifting of the line patterns to the right is dependent on the magnitude of the applied voltages V1 and V2 and the characteristics of the liquid crystal layer and the diffraction grating and is twice as much as similar voltages V1 and V2 would achieve in the embodiment 10 of FIG. 1A since in the latter device, the incident light has passed twice through the phase shifting liquid crystal layer 31.

It will be appreciated that as was previously described for the embodiment 10 of FIG. 1A, the line patterns 21 will be shifted to the right if the applied voltage V1 is higher than the voltage V2 and to the left if it is lower.

By still considering the case in which the object over which the line patterns 21 are projected is flat and held parallel with the device 30, FIG. 3, i.e., parallel with the frontal surface of the electrode layer 33, the projected line patterns 21 would similarly shift in parallel to the right or left depending on the applied voltages V1 and V2 as was described for the embodiment 10 of FIG. 1C.

Then as was described above for the embodiment 10 of FIG. 1A, by applying time varying voltage patterns V1 and V2 to the ends 37 and 38, respectively, of the electrically resistive electrode layer 33, the projected line patterns 21, FIG. 1C, would shift to the right or left following the pattern of the applied voltages V1 and V2. For example, by holding the voltage V2 constant and applying a voltage level V1 that varies as a sinusoidal function of time, then the projected line patterns 21 will similarly scan the object surface to the right and left (without any rotation) within a range determined by the amplitude of the sinusoidal voltage V1. It will also be appreciated by those skilled in the art that the voltage V1 may be varied over time using any arbitrary profile, and that the projected line patterns 21 would then similarly scan (i.e., shift to the right and left) over the object. It will also be appreciated that one may choose to vary both voltages V1 and V2 as a function of time to obtain a desired scanning (shifting) of the light patterns 21 over the said object.

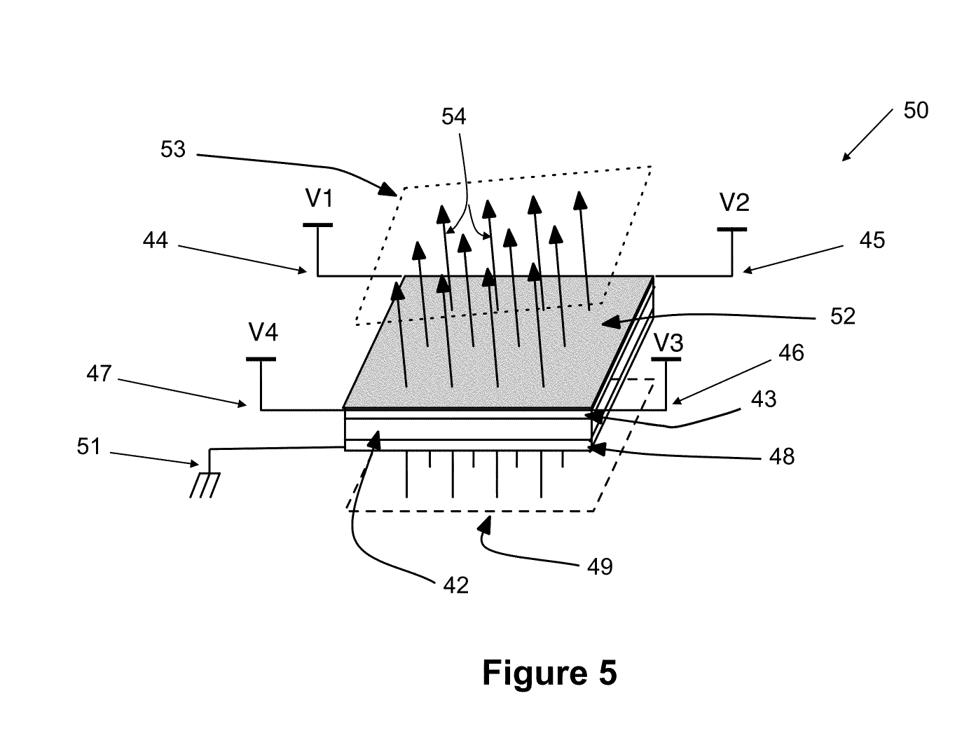

In the embodiments 10 of FIG. 1A and 30 of FIG. 4, a time varying voltage level was generated along the length and over the surface of the electrically resistive electrode layer 11 (33) by applying the voltages V1 and V2 to one end (edges) 18 (37) and 19(38), respectively, of the electrically resistive electrode layers. It will be, however, appreciated by those skilled in the art that varying voltage levels may be similarly generated along the widths as well as lengths of the electrically resistive electrode layers 11 and 33. Such a method of applying a linearly varying voltage levels over the surface of an electrically resistive electrode layer such as the layer 11 (33) of FIG. 1A (FIG. 3) is described below using a perspective view of the embodiment 10 of FIG. 1A is shown in the schematic of FIG. 5.

In FIG. 5, an isometric view of the embodiment 10 of FIG. 1A is used to illustrate the embodiment 50 of the scanning pattern device. In the schematic of FIG. 5, the scanning pattern projection device 10 is shown to be configured to achieve phase shifting of the incident coherent, monochromic and parallel light over the two-dimensional plane of the liquid crystal layer 42 (14 in the embodiment 10 of FIG. 1A). As can be seen in FIG. 5, in the embodiment 50, the (top) electrically resistive electrode 43 (11 in the embodiment 10 of FIG. 1A) is provided by four corner terminals 44, 45, 46 and 47 for applying voltages V1, V2, V3 and V4, respectively, to the electrically resistive electrode 43.

As can be seen in the schematic of FIG. 5, similar to the embodiment 10 of FIG. 1A, the embodiment 50, its liquid crystal layer 42 is similarly sandwiched between a highly conductive electrode layer 48 and the aforementioned electrically resistive electrode layer 43. Similarly and again for the sake of simplicity, the electrically resistive electrode layer 43 is considered to have a uniform resistivity over its entire surface. Both electrode layers 43 and 48 are considered to be transparent to the passing of coherent, monochromic and parallel incident light 49 (15 in the embodiment 10 of FIG. 1A). The highly conductive electrode layer 48 is grounded at a certain point, such as at ground 51, as shown in FIG. 5. A diffraction grating layer 52 (23 in the embodiment 10 of FIG. 1A) is positioned over the electrically resistive layer 43.

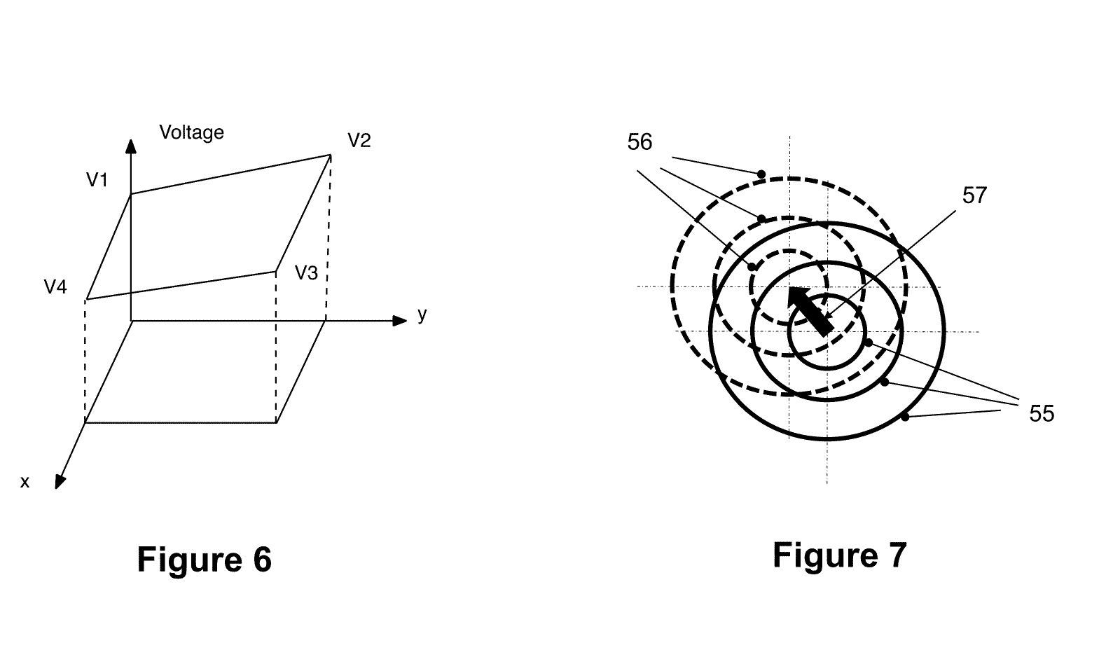

As was previously indicated, the four corners of the electrically resistive electrode 43 are provided with terminals 44, 45, 46 and 47 which are connected to an electronic circuitry to be described below for applying voltages V1, V2, V3 and V4, respectively, as shown in FIG. 5. As a result, for the considered uniform electrical resistivity of the electrode layer 43, a linearly varying electric potential pattern is then distributed over the surface of the electrode layer 43, as shown in FIG. 6. In which case, the electric field along the width and length of the liquid crystal layer 42 between the electrically resistive electrode layer 43 and the highly conductive and grounded (or any reference voltage) layer 48 will be similarly linearly varied. As a result, the liquid crystal layer 42 will shift the phase of the incoming coherent, monochromic and parallel incident light 49 proportionally to the applied varying electric field levels, the pattern of which corresponds to the pattern of the potential distribution of FIG. 6 over the surface of electrically resistive electrode layer 43, as shown in FIG. 5 by the plane 53 for the incident light 54 that has passed through the liquid crystal layer 42. The magnitude of the phase shift along the length and width of the liquid crystal layer 42 of the incident light 49 is dependent on the level of the voltages V1, V2, V3 and V4, FIGS. 5 and 6, as was similarly described for the embodiment 10 of FIG. 1A.

It will be appreciated by those skilled in the art that the diffraction grating layer 52, FIG. 5, may be designed to project a varieties of strip patterns. For example, circular hole patterns may be used to project a series of concentered circle strip patterns shown in solid lines 55 in FIG. 7 over the object, which for the sake of simplicity is considered to be a flat plane and parallel to the plane of the diffraction grating layer 52. Now by applying different voltages V1, V2, V3 and V4 to the terminals 44, 45, 46 and 47, respectively, for example as shown in FIG. 6, the previously described phase shifting of the said incident light 49, FIG. 5, will cause the projected circle strip patterns 55 to be shifted depending on the relative magnitudes of the applied voltages, for example, as shown by dashed lines 56 and indicated by the shifting arrow 57 in FIG. 7.

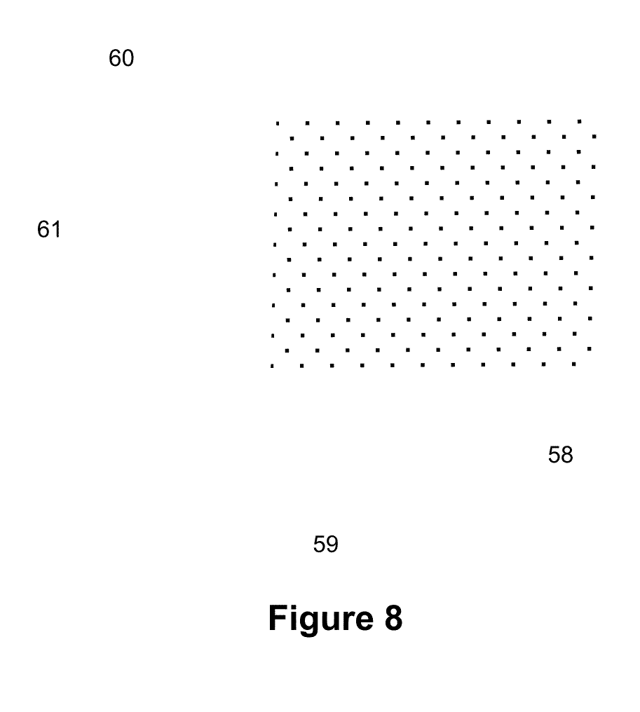

Another example of diffraction grating patterns that may be used for the diffraction grating layer 52, FIG. 5, is shown in the schematic of FIG. 8. In this example, diffraction grating layer 58 alone is shown (without the remaining components of the device of the embodiment 50 of FIG. 5). The incident coherent, monochromic and parallel light 59 passing through the diffraction grating layer 58 (e.g., causing the diffracting light 61) will then project a two-dimensional grid pattern 60 over the aforementioned object as was previously described. Now by applying different voltages V1, V2, V3 and V4 to the terminals 44, 45, 46 and 47, respectively, for example as shown in FIG. 6, the previously described phase shifting of the incident light 49, FIG. 5, will cause the projected grid pattern 60 to be similarly shifted to the right or left and/or up and down depending on the relative magnitudes of the applied voltages.

It will be appreciated by those skilled in the art that the amount of the shifting of the circular strip patterns 55 of FIG. 7 and the grid pattern 60 of FIG. 8 are similarly dependent on the relative magnitudes of the applied voltages V1, V2, V3 and V4; the characteristics of the liquid crystal layer 42, and the diffraction grating pattern, FIG. 5.

It will also be appreciated by those skilled in the art that the voltage V1, V2, V3 and V4 may be varied over time using any arbitrary profile, and that the projected circular strip patterns 55 of FIG. 7 and the grid pattern 60 of FIG. 8 would then similarly generate a two-dimensional scanning (i.e., shift to the right and left and/or up and down) of the surface of the object.

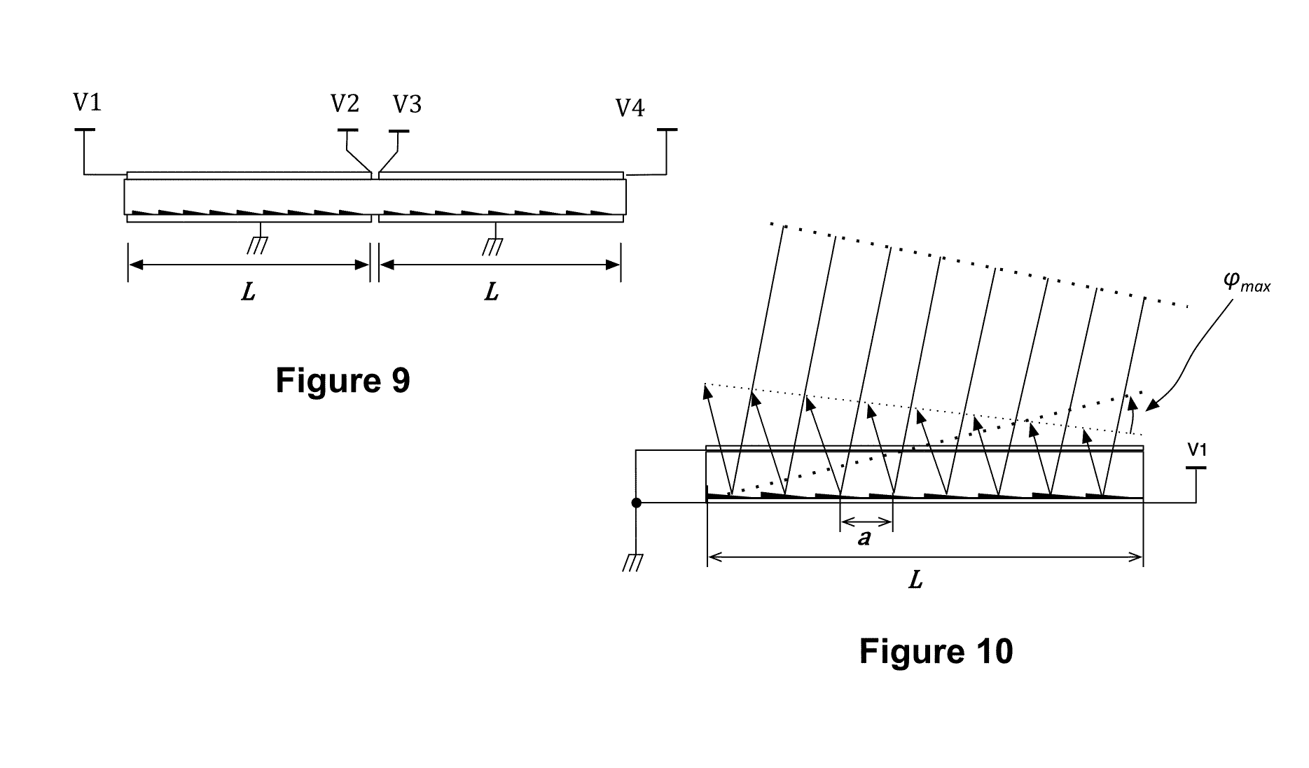

It will be appreciated by those skilled in the art that the phase shifting ability of a thin layer of liquid crystal such as those described for the above methods and devices for projecting scanning patterns over objects is rather limited and the resulting angle between the incident wave front and the phase shifted wave front is relatively small. Thus, multiple strips (sections) of scanning pattern projection devices, such as those shown in the cross-sectional views of FIGS. 1A or 4, can be assembled in series as shown in the cross-sectional view of FIG. 9. In the cross-sectional view of FIG. 9 only two such sections of the device shown in FIG. 4, each with a width of L are shown to be provided. It is, however, appreciated by those skilled in the art as many such sections may be provided in a device to achieve the required span of the projected scanning pattern.

FIG. 10 illustrates a cross-sectional view of a single device section of the scanning pattern projection device of FIG. 9. In the device of FIG. 9 for projecting scanning patterns over objects, each section of the device is constructed as the diffractive elements that work in reflection configuration as illustrated in cross-sectional view FIG. 4. It is, however, appreciated by those skilled in the art that the device sections of the scanning pattern projection device of FIG. 9 may also be constructed as described for the device of FIG. 1A for operation with through passing incident light. In either case, the incident light is considered to be coherent, monochromic and parallel.

In the cross-sectional view of FIG. 10, all components of the device are considered to be as those described for the cross-sectional view of FIG. 4. In FIG. 10, the device section is shown to have a width of L, and a diffractive grating period of a.

It will be appreciated by those skilled in the art that if the required deflective angle between the incident wave front and the phase-shifted wave front φₘₐₓ (as shown in FIG. 10) and when the maximum phase shift angle for the liquid crystal layer can provide is φₘₐₓ, then the length of device L has to be smaller than

$${L}_{max} = \frac{{φ}_{max} λ}{2 π tan {ϕ}_{max}} ,$$

where λ is the wavelength of the incident coherent, monochromic and parallel light. It is also appreciated by those skilled in the art that the device can deflect wave front in both positive and negative direction, thereby the total deflection range is 2φₘₐₓ, i.e., from −φₘₐₓ to φₘₐₓ.

For example, consider the case in which the maximum deflective angle between the incident wave front and the phase-shifted wave front is to be φₘₐₓ shown in FIG. 10. In this example, the incident light is considered to have a wavelength λ=633 nm, while the diffractive grating period is considered to be α=3.3μm (i.e., 300 lines per millimeter), which makes the diffraction angle for each grating, FIG. 3, for a

$${θ}_{inc} = 0 to be {θ}_{diff} = arcsin \frac{λ}{a} = 11 ° .$$

Thus, in order to scan the entire range, the deflected wave front angle range should not be less than less than 11° and therefore the deflective angle between the incident wave front and the phase-shifted wave front φₘₐₓ should not be less than 5.5° . It is noted that the current maximum phase shifting capability of liquid crystal layer φₘₐₓ is given to be 8 π.

In the reflection configuration shown in FIG. 10, the light waves pass the liquid crystal layer twice, therefore the above currently available maximum phase shifting between the incident and the reflected light wave becomes 16 π. As a result, the maximum length of device section shown in FIG. 10 to achieve full scan is given as

$${L}_{max} = \frac{{φ}_{max} λ}{2 π tan {ϕ}_{max}} = 53 μ m .$$

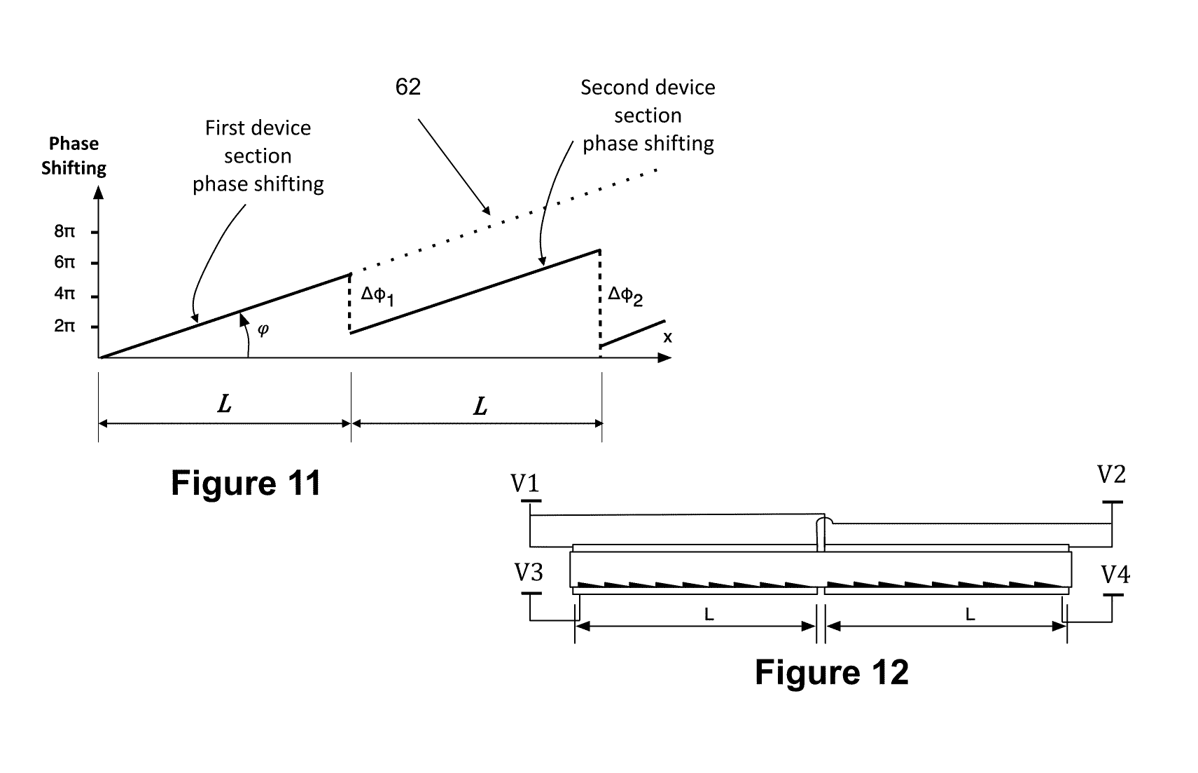

It will also be appreciated by those skilled in the art that in order to generate a continuous phase shifting across multiple sections of a scanning pattern projection device, FIG. 9, and considering the practical limitations in achieving absolute phase shifting across each section, one has to provide for an appropriate phase offset between each pair of sections. In FIG. 11, the desired phase shifted wave front is shown with a dotted line 62 making a deflective angle between the incident wave front and the phase-shifted wave front φ. As can be seen in FIG. 11, the required continuous phase shifting indicated by the dotted line cannot generally be achieved between the first and second sections of the scanning pattern projection device. To achieve phase-shifted wave front continuity, a proper phase offset Δφ₁, FIG. 11, must be provided between the two sections of the scanning pattern projection device. It will be appreciated by those skilled in the art that the phase offset Δφ₁=n₁λ, where n₁ is an integer and λ is the wavelength. Similarly, phase shifted wave front continuity between other sections of the scanning pattern projection device is achieved, making the scanning pattern projection device capable of providing continuous phase shifting along all present sections of the device. It will be appreciated by those skilled in the art that to achieve the above continuous phase shifting across multiple sections of scanning pattern projection device, FIG. 9, the voltage difference V2-V1 should be the same as the voltage difference V4-V3. And that the difference between the voltages V3 and V2 must be such that it would cause the phase offset Δφ₁, FIG. 11. Similarly, the voltage difference across all sections of scanning pattern projection device must be the same as the voltage difference V2-V1, while the voltage differences between the adjacent electrically resistive electrode top layers (33 in FIG. 4) must be such that they would provide for the required aforementioned phase offsets between the adjacent sections to ensure a continuous phase shifting across multiple sections of scanning pattern projection device.

It will also be appreciated by those skilled in the art that by varying the voltages V1, V2, V3 and V4 as a function of time in the embodiment of FIG. 9 while keeping their aforementioned relationship to ensure continuous phase shifting, a desired scanning (shifting) of the light patterns 21, FIG. 1C, over the projected object is obtained.

In an alternative embodiment of that shown in FIG. 12, the top and bottom electrode sections (layers 33 and 32 in FIG. 4) are made out of previously described electrically resistive electrode layers, otherwise they are constructed as the device of FIG. 4. The voltages to the electrically resistive electrode layers are then applied as described below to achieve a phase shifting as the one described for the embodiment of FIG. 9 and shown in FIG. 11. It is noted that in the embodiment of FIG. 9, the voltages applied to each scanning pattern projection device section is controlled separately, i.e., for the case of the two sections shown in FIG. 9, the voltages V1, V2, V3 and V4 applied to the top electrically resistive electrode layer sections are controlled as was previously described while the opposite electrode layers are connected to a common ground, thereby generating the desired electric field gradient across the liquid crystal layer. In the embodiment of FIG. 12, however, shared voltages V1 and V2 are applied to the top electrically resistive electrode layers. And to provide for the aforementioned required phase shift offset between the device sections to achieve a continuous phase shifting along all sections of the scanning pattern projection device, bias voltages V3 and V4 are applied to the opposite electrodes as shown in FIG. 12. As a result, for a scanning pattern projection device constructed with n sections, it would only require n+2 voltage control signals to achieve a continuous phase shifting along all sections of the scanning pattern projection device.

It will be appreciated by those skilled in the art that by varying the voltages V1, V2, V3 and V4 as a function of time in the embodiment of FIG. 12 while keeping their aforementioned relationship to ensure continuous phase shifting, a desired scanning (shifting) of the light patterns 21, FIG. 1C, over the projected object is obtained.

It will also be appreciated by those skilled in the art that the voltages applied to the electrically conductive electrodes in all the above embodiments, for example the voltages V1, V2, V3 and V4 in the embodiments of FIGS. 1A, 4, 5, 9, 10 and 12, are relative to the device ground.

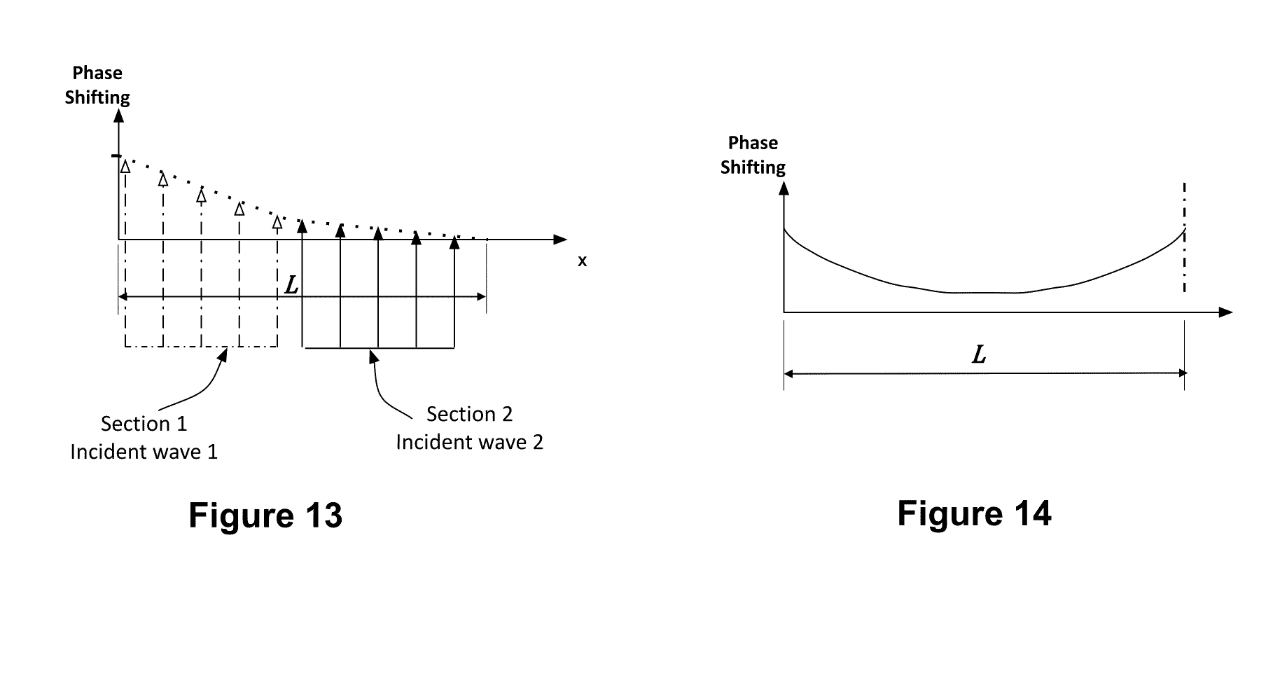

In all the above embodiments, the electrically resistive electrode layers are considered to have a constant electrical resistance along the width and length of the electrodes and that the thickness of the liquid crustal layers to be also constant. It will be, however, appreciated by those skilled in the art that the electrical resistance of the electrically resistive electrode layers may also be varied along their width and/or along their lengths. As a result, a desired non-uniform voltage and thereby phase shifting can be obtained along the width and/or length of each electrode layer. For example, by providing different electrical resistivity on the electrically resistive electrode layers of two adjacent sections of a scanning pattern projection device such as the one shown in FIG. 9, each section would provide a different phase shifting profile along the width L of the section as shown in FIG. 13. It will also be appreciated by those skilled in the art that by varying the electrical resistivity of the different sections of a scanning pattern projection device along their width and/or length, the phase shifting profile over the entire surface of the scanning pattern projection device may be arbitrarily shaped, as long as they are monotonically decreasing due to the increasing total resistance from each high voltage end of the electrode. In the embodiment of FIG. 13, two self-coherent incident waves are shown to pass through the aforementioned adjacent two sections. As a result, two different diffraction patterns are projected onto the object surface. The difference between the deflected wave front of the two incident waves is controllable by varying the voltages applied to the electrically resistive electrode layers as was previously described to obtain the desired variation in the diffraction pattern.

It will also be appreciated that similar variation in the phase shifting may be obtained by varying the thickness of the liquid crystal layer along the width and/or length of different sections of a scanning pattern projection device. One advantage of this method is that it can create a non-monotonically decreasing (increasing) phase shifting profile, as shown in FIG. 14.

It will also be appreciated by those skilled in the art that the electrodes layers of the scanning pattern projection device sections besides being electrically resistive, may also be fabricated with combined inductance and/or capacitance and/or semiconductor characteristic. Such added electrical inductance or capacitances may be more local or may be distributed over certain region of the electrode layer to achieve certain regional pattern scanning effects. As a result, the scanning pattern projection device can be provided with a controllable dynamics phase shifting response by providing properly controlled input voltage excitations to the electrode layers. Noting that in the aforementioned embodiments, electrode layers were considered to have uniform resistivity along the width (and/or length) of the device sections considered, thereby causing the voltage to drop uniformly along the width (and/or length) of each section of the scanning pattern projection device. Then if, for example, a uniform inductance is provided over the conductive electrode layer, then the change in voltage along the width (and/or length) of each section of the scanning pattern projection device becomes proportional to the rate of change of the passing current at each point along the width (and/or length) of the section. In general and with the current technology, it is difficult to fabricate electrode layers with zero or even very low electrical resistivity. As a result, in general combinations of effects will be experienced depending on the resistivity and inductivity distribution over the surface of the electrode layer and the applied voltage profiles as a function of time in each section of the scanning pattern projection device. In practice, one may therefore design the electrode layers within their practical limitations to achieve optimal projected pattern scanning characteristics depending on the selected patterns and the application at hand.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A scanning apparatus, comprising:
a first conductive layer extending between opposed ends and being at a reference potential;
a second conductive layer extending widthwise between opposed first and second ends and situated apart from the first conductive layer, the second conductive layer comprising a resistive layer having a resistivity which is substantially uniform between the first and second ends of the second conductive layer such that a voltage potential applied (V) across the second conductive layer will range uniformly across the width of the second conductive layer from a first voltage potential (V1) at the first end to a second voltage potential (V2) at the second end;
a liquid crystal layer situated between the first and second conductive layers and configured to variably shift a phase of light incident thereto linearly based upon a voltage potential across the first and second conductive layers; and
a diffraction grating extending between first and second ends and situated adjacent to one of the first and second conductive layers, the diffraction grating configured to receive the phase shifted light from the liquid crystal layer and diffract the phase shifted light.

2. The apparatus of claim 1, further comprising a voltage source which generates the voltage potential (V) as a time varying voltage so as to generate a continuously varying phase shift across the liquid crystal layer.

3. The apparatus of claim 1, wherein the phase shifted diffracted light projects a pattern on an object.

4. The apparatus of claim 3, wherein the voltage potential (V) is varied as a function of time so as to scan the surface of the object with the pattern.

5. The apparatus of claim 1, wherein the diffraction grating comprises a reflective diffraction grating.

6. The apparatus of claim 5, wherein the diffraction grating reflects the phase shifted light back through the liquid crystal layer.

7. The apparatus of claim 1, wherein the diffraction grating comprises a reflective diffraction grating and is coupled to receive the phase shifted light and reflect the phase shifted light back through the liquid crystal layer for a second phase shifting.

8. The apparatus of claim 1, wherein the first and second conductive layers are transparent to pass light incident thereto.

9. The apparatus of claim 1, wherein the first and second conductive layers have at least one of an inductivity and a capacitance.

10. A scanning pattern projection apparatus, comprising:
a first conductive layer extending between opposed ends defining a width and opposed edges defining a length, the first conductive layer being at a reference potential;
a second conductive layer extending between opposed ends defining a width and opposed edges defining a length, the second conductive layer comprising a resistive layer having first through fourth electrodes each separate from each other and configured to receive first through fourth respective voltage potentials (V1, V2, V3, V4, respectively), the second conductive layer having a resistivity which is substantially uniform across the length and width thereof such that voltage potentials range uniformly across the width and across the length of the second conductive layer;
a liquid crystal layer situated between the first and second conductive layers and configured to variably shift a phase of light incident thereto linearly based upon distributed voltage potentials across the first and second conductive layers; and
a diffraction grating extending between first and second ends and situated adjacent to one of the first and second conductive layers, the diffraction grating configured to receive the phase shifted light from the liquid crystal layer and diffract the phase shifted light.

11. The apparatus of claim 10, wherein the first through fourth voltage potentials (V1, V2, V3, V4, respectively) are varied over time in accordance with a voltage profile.

12. The apparatus of claim 11, wherein the first through fourth voltage potentials (V1, V2, V3, V4, respectively) are varied over time to scan an object using the projected pattern.

13. The apparatus of claim 12, wherein the projected pattern is shifted based upon relative magnitudes of the first through fourth voltage potentials (V1, V2, V3, V4, respectively).

14. The apparatus of claim 11, wherein the first through fourth voltage potentials (V1, V2, V3, V4, respectively) are varied over time to spatially shift the projected pattern over time.

15. The apparatus of claim 11, wherein the first through fourth voltage potentials (V1, V2, V3, V4, respectively) are varied over time to generate a two-dimensional scanning pattern projected onto an object.

16. The apparatus of claim 10, wherein the first through fourth voltage potentials (V1, V2, V3, V4, respectively) are varied such that V2−V1=V4−V3.

17. The apparatus of claim 10, wherein the diffraction grating has a diffraction grating pattern configured so that the diffracted phase shifted light is projected to form a circular or grid pattern on an object.

18. The apparatus of claim 10, wherein the first through fourth electrodes are located at first through fourth corners, respectively, of the second conductive layer.

19. The apparatus of claim 10, wherein the phase shifted diffracted light projects a pattern on an object.

20. The apparatus of claim 10, wherein at least one of the first through fourth voltage potentials (V1, V2, V3, V4, respectively) are varied as a function of time so as to scan a surface of an object with the diffracted phase shifted light projected as a pattern.

21. An apparatus, comprising:
a plurality of scanning projection devices, each scanning projection device situated adjacent to another of the plurality of scanning projection devices and comprising:
a first conductive layer extending between opposed ends and being at a reference potential;
a second conductive layer extending widthwise between opposed first and second ends and situated apart from the first conductive layer, the second conductive comprising a resistive layer having a resistivity which is substantially uniform between the first and second ends of the second conductive layer such that a voltage potential (V) applied across the second conductive layer will range uniformly across the width of the second conductive layer from a first voltage potential (V1) at the first end to a second voltage potential (V2) at the second end;
a liquid crystal layer situated between the first and second conductive layers and configured to variably shift a phase of light incident thereto linearly based upon a voltage potential across the first and second conductive layers; and
a diffraction grating extending between first and second ends and situated adjacent to one of the first and second conductive layers, the diffraction grating configured to receive the phase shifted light from the liquid crystal layer and diffract the phase shifted light.

22. The apparatus of claim 21, wherein the plurality of scanning projection devices are arranged in a linearly pattern.

23. The apparatus of claim 21, where the voltage potential (V) applied across each scanning projection devices, phase shifts the phase shifted light by a phase offset (Δφ₁).

24. The apparatus of claim 21, wherein the voltage potential (V) applied across the second conductive layer of at least two of the scanning projection devices is equal so as to obtain the same slope of a wave front.

25. The apparatus of claim 21, wherein the voltage potential (V) applied across the second conductive layer of at least two of the scanning projection devices are varied to obtain a desired phase shift profile.

26. The apparatus of claim 21, wherein the phase shifted diffracted light projects a pattern on an object.

27. The apparatus of claim 26, wherein at least one voltage potential (V) of at least one of the plurality of scanning projection devices is varied as a function of time so as to scan a surface of an object with a pattern formed by a projection of the diffracted phase shifted light.

28. The apparatus of claim 21, wherein the first and second conductive layers have at least one of an inductivity and a capacitance.
